(19) United States
(12) Patent Application Publication
(10) Pub. No.: US 2025/0332839 A1
(43) Pub. Date: Oct. 30, 2025

(54) POUCH STORAGE BODY

(71) Applicant: Roland DG Corporation, Hamamatsu-shi (JP)

(72) Inventors: Yuki TOMITA, Hamamatsu-shi (JP); Satoshi HIRAIDE, Hamamatsu-shi (JP)

(21) Appl. No.: 19/265,165

(22) Filed: Jul. 10, 2025

Related U.S. Application Data
(63) Continuation of application No. PCT/JP2023/001928, filed on Jan. 23, 2023.

(51) Int. Cl. B41J 2/175

(52) U.S. Cl. CPC B41J 2/17513; B41J 2/17553; B41J 2002/17516

(57) ABSTRACT

A pouch storage body includes a storage housing with a tubular shape, and a stored structure to be stored in the storage housing, together with an ink pouch. The stored structure includes a front wall portion to cover a front portion of a bag portion of the ink pouch from a front except for a supply portion, a rear wall portion to cover a rear portion of the bag portion of the ink pouch from a rear, and a connecting portion to connect the front wall portion and the rear wall portion.

### CROSS REFERENCE TO RELATED APPLICATIONS

This application is a Continuation Application of PCT Application No. PCT/JP2023/001928 filed on Jan. 23, 2023. The entire contents of this application are hereby incorporated herein by reference.

### BACKGROUND OF THE INVENTION

### 1. Field of the Invention

The present invention relates to pouch storage bodies to store ink pouches.

### 2. Description of the Related Art

Examples of a printer include an inkjet printer that performs printing by ejecting ink on a medium such as paper. The inkjet printer includes an ink cartridge that can be attached to and detached from a printer body. The conventional art related to an ink cartridge is disclosed in Japanese Patent No. 6341120.

The ink cartridge disclosed in Japanese Patent No. 6341120 includes an ink pouch filled with ink and a pouch storage body that stores the ink pouch. The ink pouch includes a bag portion filled with the ink, and a supply portion to supply the ink, with which the bag portion is filled, to the outside. When ink that is cured when irradiated with ultraviolet light is adopted, the pouch storage body needs to cover the entirety of the bag portion (in all six directions: the top, bottom, left, right, front, and rear) except for the supply portion.

### SUMMARY OF THE INVENTION

The pouch storage body includes a lower wall portion and an upper wall portion located to sandwich the bag portion therebetween in a thickness direction, and a hinge portion connecting the lower wall portion and the upper wall portion. The pouch storage body is a resin-molded article that can be manufactured by injection molding or the like. The lower wall portion, the upper wall portion, and the hinge portion are integrally molded in an unfolded state. If the entirety of the bag portion of the ink pouch can be covered with a simple configuration, manufacturing costs can be reduced.

Example embodiments of the present invention provide pouch storage bodies each with a simple configuration that reduces manufacturing costs.

A pouch storage body according to an example embodiment of the present invention is capable of storing an ink pouch including a bag portion filled with printing ink that is curable when irradiated with ultraviolet light, and a supply portion to supply the printing ink, with which the bag portion is filled, to an outside, the pouch storage body including a storage housing with a tubular shape, and a stored structure that can be stored in the storage housing, together with the ink pouch. When a length direction of the ink pouch is defined as a front-rear direction, and a side on which the supply portion is provided is defined as a front, the stored structure includes a front wall portion to cover a front portion of the bag portion of the ink pouch from the front except for the supply portion, a rear wall portion to cover a rear portion of the bag portion of the ink pouch from a rear, and a connecting portion connecting the front wall portion and the rear wall portion.

In a pouch storage body according to an example embodiment of the present invention, the front wall portion includes a front surrounding portion extending rearward from an entire edge of the front wall portion and to surround the front portion of the bag portion, and the rear wall portion includes a rear surrounding portion extending forward from an entire edge of the rear wall portion and to surround the rear portion of the bag portion.

A pouch storage body according to an example embodiment of the present invention includes a storage to store an ink pouch including a bag portion filled with printing ink that is curable when irradiated with ultraviolet light, and a supply portion to supply the printing ink, with which the bag portion is filled, to an outside, and a plate-shaped structure with a box shape to cover an entirety of the bag portion of the ink pouch except for the supply portion.

In a pouch storage body according to an example embodiment of the present invention, preferably, the plate-shaped structure is made of coated cardboard.

In a pouch storage body according to an example embodiment of the present invention, preferably, an edge of the plate-shaped structure includes an overlapping portion to overlap an edge adjacent to the edge when the plate-shaped structure is assembled into a box shape, and the overlapping portion is bonded to the adjacent edge or an insertion portion provided in the adjacent edge is inserted into an insertion hole formed in the overlapping portion.

A pouch storage body according to an example embodiment of the present invention further includes a lower cover portion to cover a lower portion of the bag portion, an upper cover portion to cover an upper portion of the bag portion, and an end cover portion to cover a front portion and/or a rear portion of the bag portion, in which the end cover portion includes a first extension portion extending from an edge of the lower cover portion, and a second extension portion extending from an edge of the upper cover portion, and both a tip of the first extension portion and a tip of the second extension portion are located between the lower cover portion and the upper cover portion.

Example embodiments of the present invention provide pouch storage bodies each with a simple configuration that reduces manufacturing costs.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a pouch storage body according to a first example embodiment of the present invention.

FIG. 2 is a perspective view of a stored structure and an ink pouch that can be placed on the stored structure.

FIG. 3 is a perspective view of the stored structure on which the ink pouch, and a storage housing.

FIG. 4A is a view describing the pouch storage body when viewed from the rear as indicated by arrow 4A in FIG. 1, and FIG. 4B is a cross-sectional view taken along line B-B in FIG. 4A.

FIG. 5 is a perspective view of a pouch storage body according to a second example embodiment of the present invention.

FIG. 6 is a plan view of a plate-shaped structure in a state in which the pouch storage body illustrated in FIG. 5 is unfolded.

FIG. 7A is a cross-sectional view taken along line 7A-7A in FIG. 5, and FIG. 7B is a view describing the pouch storage body when viewed from the rear as indicated by arrow 7B in FIG. 5.

FIG. 8 is a cross-sectional view of a front portion and a rear portion of a pouch storage body according to a third example embodiment of the present invention.

FIG. 9A is a cross-sectional view of a rear portion of a pouch storage body according to a fourth example embodiment, and FIG. 9B is a view describing a configuration when the remaining amount of ink in an ink pouch decreases from the state illustrated in FIG. 9A.

FIG. 10 is a perspective view of a pouch storage body according to a fifth example embodiment of the present invention.

FIG. 11 is an unfolded view of the pouch storage body illustrated in FIG. 10.

FIG. 12 is a cross-sectional view taken along line 12-12 in FIG. 10.

FIG. 13 is a cross-sectional view taken along line 13-13 in FIG. 10.

### DETAILED DESCRIPTION OF THE EXAMPLE EMBODIMENTS

Example embodiments will be described with reference to the accompanying drawings. In the figures, Fr, Rr, Le, Ri, Up, and Dn represent the front, the rear, the left, the right, the top or up, and the bottom or down, respectively.

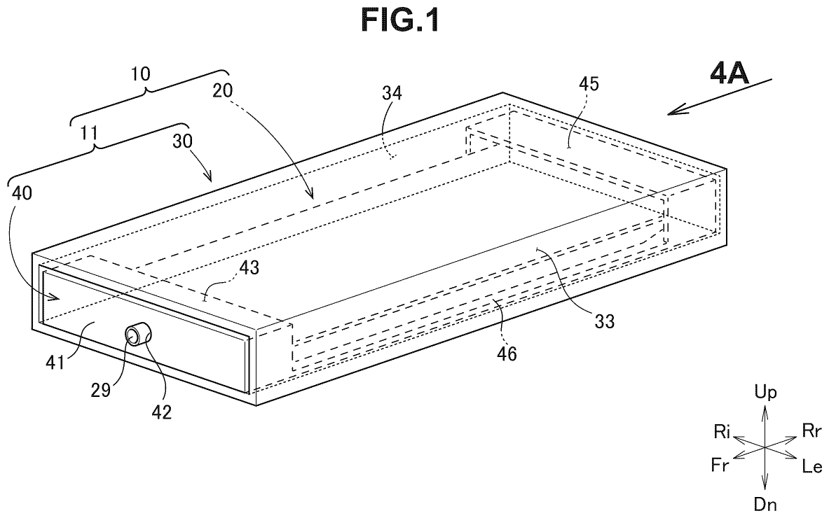

Referring to FIG. 1, examples of a printer include an inkjet printer (not illustrated) that performs printing by ejecting ink (printing ink) onto a medium such as paper. The inkjet printer includes an ink cartridge 10 that can be replaced by being attached to and detached from a printer body.

The ink cartridge 10 includes an ink pouch 20 filled with ink that is cured when exposed to ultraviolet light, and a pouch storage body 11 that stores the ink pouch 20.

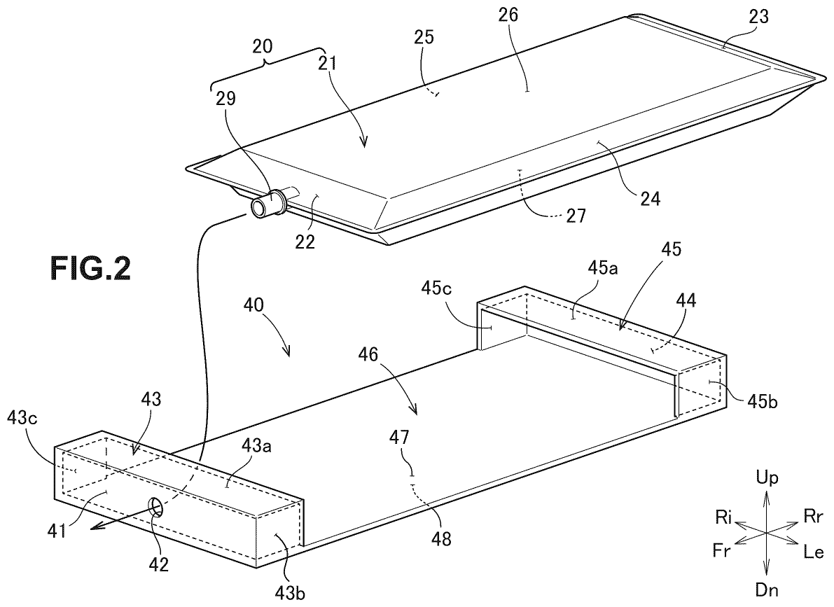

Referring to FIG. 2, the ink pouch 20 includes a bag portion 21 having a flat shape that can be filled with ink by overlapping the edges of two sheets, and a supply portion 29 provided at an end portion of the bag portion 21 and to supply the ink to the outside.

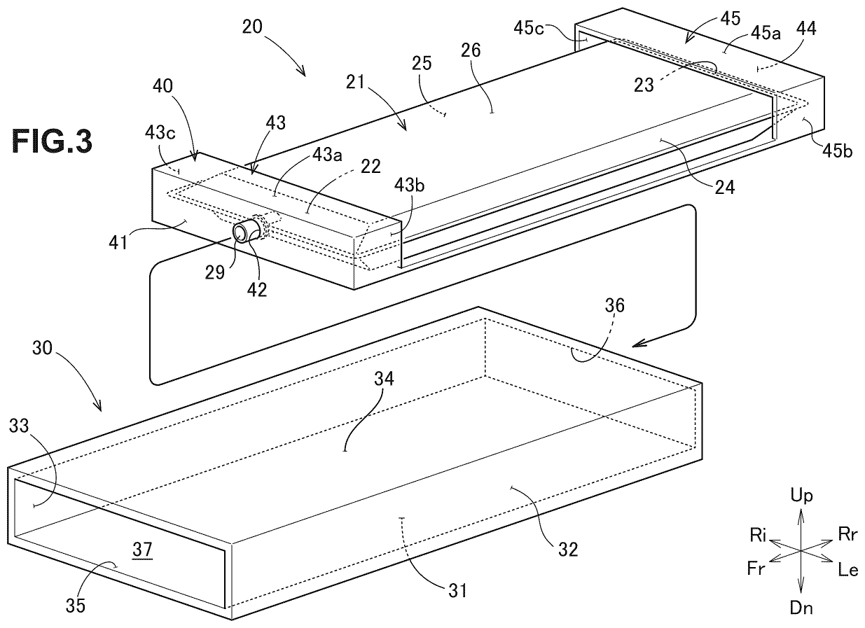

The pouch storage body 11 includes a storage housing 30 with a tubular shape (see FIG. 3), and a stored structure 40 (see FIG. 2) that can be stored in the storage housing 30, together with the ink pouch 20. Both the storage housing 30 and the stored structure 40 are made of resin.

A length direction of the ink pouch 20 is defined as a front-rear direction, and a side on which the supply portion 29 is provided is defined as the front. A height direction (thickness direction) of the ink pouch 20 is defined as an up-down direction. A width direction of the ink pouch 20 is defined as a left-right direction. Incidentally, the front, rear, top, bottom, left, and right are used for convenience in describing directions, and do not limit the directions in which the ink pouch of the present example embodiment is used.

The stored structure 40 is formed by integrating a front wall portion 41 with a plate shape and capable of covering a front portion 22 of the bag portion 21 from the front, a rear wall portion 44 with a plate shape and capable of covering a rear portion 23 of the bag portion 21 from the rear, and a connecting portion 46 with a plate shape and connecting a lower end of the front wall portion 41 and a lower end of the rear wall portion 44.

The connecting portion 46 can cover a lower portion 27 of the bag portion 21 from below. It can also be said that an upper surface 47 of the connecting portion 46 is a surface on which the lower portion 27 of the bag portion 21 can be placed. The front wall portion 41 has a through-hole 42 through which the supply portion 29 of the ink pouch 20 can penetrate. The through-hole 42 is located at the center of the front wall portion 41 in the width direction. Incidentally, instead of the through-hole 42, a cutout that opens upward may be provided.

The front wall portion 41 includes a front surrounding portion 43 extending rearward from the entire edge of the front wall portion 41 and capable of surrounding the front portion 22 of the bag portion 21. The front surrounding portion 43 includes a front upper surrounding portion 43a with a plate shape and extending rearward from an upper edge of the front wall portion 41, a front left surrounding portion 43b with a plate shape and extending rearward from a left edge of the front wall portion 41, and a front right surrounding portion 43c with a plate shape and extending rearward from a right edge of the front wall portion 41.

The rear wall portion 44 includes a rear surrounding portion 45 extending forward from the entire edge of the rear wall portion 45 and capable of surrounding the rear portion 23 of the bag portion 21. The rear surrounding portion 45 includes a rear upper surrounding portion 45a with a plate shape and extending forward from an upper edge of the rear wall portion 44, a rear left surrounding portion 45b with a plate shape and extending forward from a left edge of the rear wall portion 44, and a rear right surrounding portion 45c with a plate shape and extending forward from a right edge of the rear wall portion 44.

Referring to FIG. 3, the storage housing 30 has a tubular shape with a length direction corresponding to the front-rear direction. The storage housing 30 includes a front opening portion 35 that opens forward, and a rear opening portion 36 that opens rearward. The front opening portion 35 and the rear opening portion 36 have a rectangular or substantially rectangular shape, for example. The storage housing 30 is formed by integrating a lower wall portion 31 with a plate shape and capable of coming into contact with (capable of facing) a lower surface 48 (see FIG. 2) of the connecting portion 46 of the stored structure 40, a left wall portion 32 with a plate shape and extending upward from a left edge of the lower wall portion 31, a right wall portion 33 with a plate shape and extending upward from a right edge of the lower wall portion 31, and an upper wall portion 34 with a plate shape and connecting an upper end of the left wall portion 32 and an upper end of the right wall portion 33.

The left wall portion 32 can cover a left portion 24 of the bag portion 21 from the left. The right wall portion 33 can cover a right portion 25 of the bag portion 21 from the right. The upper wall portion 34 can cover an upper portion 26 of the bag portion 21 from above.

A space surrounded by the lower wall portion 31, the left wall portion 32, the right wall portion 33, and the upper wall portion 34 is a storage space 37 capable of storing the stored structure 40 on which the ink pouch 20 is placed. Incidentally, the stored structure 40 on which the ink pouch 20 is placed may be stored into the storage space 37 from the rear opening portion 36 side, or may be stored into the storage space 37 from the front opening portion 35.

### [Gap]

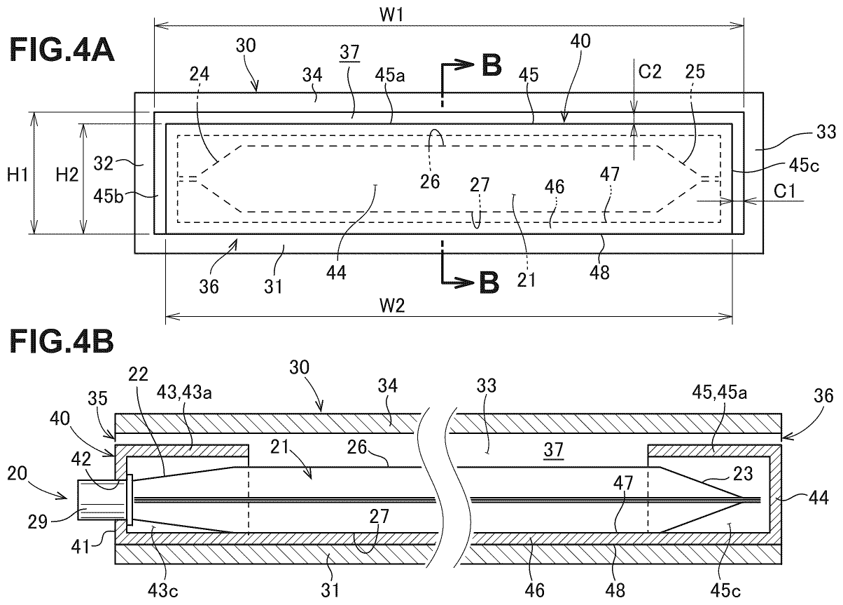

Referring to FIG. 4A, a width W1 of the storage space 37 is larger than a width W2 of the stored structure 40 (a width of the connecting portion 46, a width of the rear wall portion 44, and a width of the front wall portion 41) (W1>W2). When the stored structure 40 is stored in the storage housing 30, a gap C1 exists between the stored structure 40 and the storage housing 30 in the width direction.

A height H1 of the storage space 37 is higher than a height H2 of the stored structure 40 (a height of the rear wall portion 44 and a height of the front wall portion 41) (H1>H2). When the stored structure 40 is stored in the storage housing 30, a gap C2 exists between the stored structure 40 and the storage housing 30 in the height direction.

Referring to FIG. 4B, the stored structure 40 does not protrude from the opening portions 35 and 36 of the storage housing 30. In detail, the rear wall portion 44 of the stored structure 40 is located in the storage space 37. The front wall portion 41 of the stored structure 40 is located in the storage space 37 of the storage housing 30.

Referring to FIG. 2 and FIG. 3, the pouch storage body 11 includes only two components: the stored structure 40 on which the ink pouch 20 can be placed, and the storage housing 30 with a tubular shape inside which the stored structure 40 on which the ink pouch 20 is placed can be stored. The stored structure 40 includes the front wall portion 41 and the rear wall portion 44. Namely, the storage housing 30 can cover the left, right, top, and bottom of the bag portion 21 of the ink pouch 20. The stored structure 40 can cover the front and rear of the bag portion 21 of the ink pouch 20. Compared to the conventional art, the entirety of the bag portion 21 of the ink pouch 20 (in all six directions: the top, bottom, left, right, front, and rear) can be covered with a simple configuration, and manufacturing costs can be reduced.

Referring to FIG. 2, the front wall portion 41 includes the front surrounding portion 43 extending rearward from the entire edge of the front wall portion 41 and capable of surrounding the front portion 22 of the bag portion 21. Referring to FIGS. 1 and 4B, ultraviolet light entering the storage space 37 through the front opening portion 35 of the storage housing 30 can be blocked.

Similarly, the rear wall portion 44 includes the rear surrounding portion 45 extending forward from the entire edge of the rear wall portion 45 and capable of surrounding the rear portion 23 of the bag portion 21. Ultraviolet light entering the storage space 37 through the rear opening portion 36 of the storage housing 30 can be blocked.

Referring to FIG. 3, the front surrounding portion 43 and the rear surrounding portion 45 are not essential components. However, the falling off of the ink pouch 20 from the stored structure 40 during assembly work can be reduced or prevented by providing the front surrounding portion 43 and the rear surrounding portion 45. The stored structure 40 on which the ink pouch 20 is placed is easily inserted into the storage housing 30.

Referring to FIG. 4A, the gap C1 and the gap C2 are set between the storage housing 30 and the stored structure 40. Therefore, as illustrated in FIG. 3, the work of storing the stored structure 40 on which the ink pouch 20 is placed into the storage housing 30 becomes smooth. When the gap C1 and the gap C2 are not set and the stored structure 40 and the storage housing 30 are fitted together without the gaps C1 and C2, ultraviolet light entering the storage space 37 is easily blocked. A configuration in which the front surrounding portion 43 and the rear surrounding portion 45 are not provided may be used.

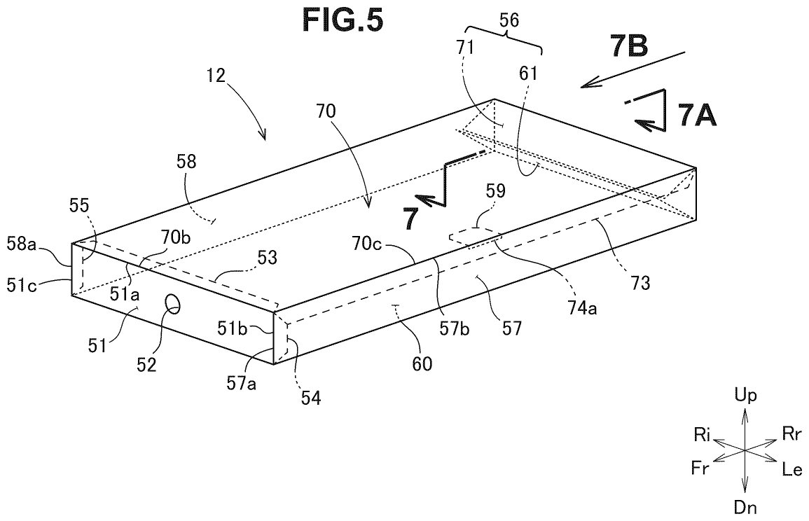

FIG. 5 illustrates a pouch storage body 12 according to a second example embodiment capable of storing the ink pouch 20 (see FIG. 2). The pouch storage body 12 has a substantially rectangular parallelepiped shape, and can cover the entirety (the front, rear, left, right, top, and bottom) of the bag portion 21 of the ink pouch 20 except for the supply portion 29 (see FIG. 2).

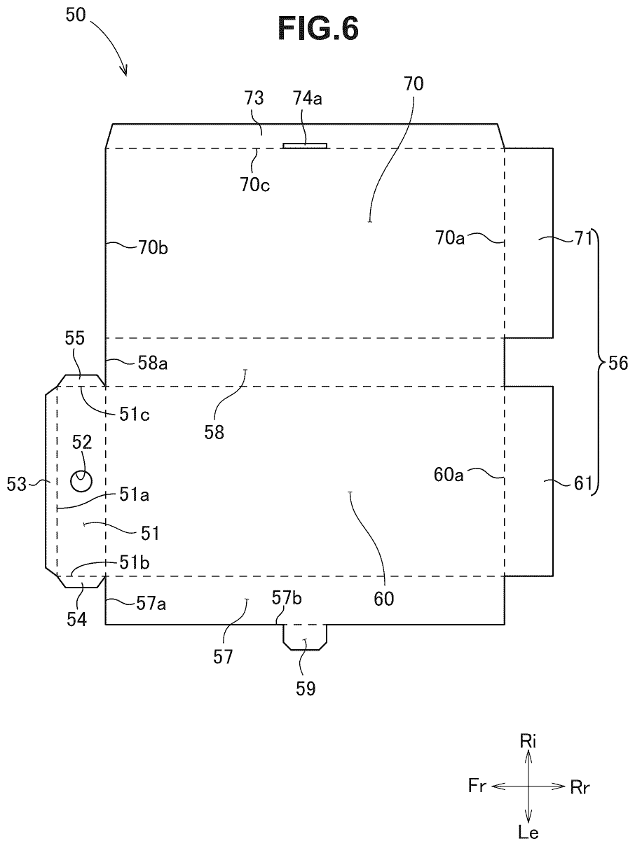

Referring to FIG. 6, the pouch storage body 12 can have a box shape by folding one plate-shaped structure 50 along dashed lines (valley fold lines). In detail, the pouch storage body 12 is formed by integrating a front cover portion 51 having a through-hole 52 through which the supply portion 29 of the ink pouch 20 can penetrate, and capable of covering the front portion 22 of the bag portion 21 from the front, a rear cover portion 56 (end cover portion) capable of covering the rear portion 23 of the bag portion 21 from the rear, a left cover portion 57 capable of covering the left portion 24 of the bag portion 21 from the left, a right cover portion 58 capable of covering the right portion 25 of the bag portion 21 from the right, a lower cover portion 60 capable of covering the lower portion 27 of the bag portion 21 from below, and an upper cover portion 70 capable of covering the upper portion 26 of the bag portion 21 from above.

The material of the plate-shaped structure 50 is, for example, coated cardboard. However, the material is not limited as long as the thickness of the plate-shaped structure 50 is set to allow folding.

The front cover portion 51 is connected to a front edge of the lower cover portion 60. The left cover portion 57 is connected to a left edge of the lower cover portion 60. The right cover portion 58 is connected to a right edge of the lower cover portion 60. The upper cover portion 70 is connected to an upper edge of the right cover portion 58. Incidentally, the shape of the plate-shaped structure 50 (the outer shape of the pouch storage body 12 in FIG. 5 when unfolded) can be changed as appropriate. For example, the front cover portion 51 may be connected to the upper cover portion 70 instead of the lower cover portion 60.

When the plate-shaped structure 50 is assembled into a box shape, an upper edge 51a of the front cover portion 51 is adjacent to a front edge 70b of the upper cover portion 70. The upper edge 51a includes an overlapping portion 53 capable of overlapping the front edge 70b. The overlapping portion 53 is bonded to the front edge 70b, for example, by gluing.

Similarly, when the plate-shaped structure 50 is assembled into a box shape, a left edge 51b of the front cover portion 51 is adjacent to a front edge 57a of the left cover portion 57. The left edge 51b includes an overlapping portion 54 capable of overlapping the front edge 57a. The overlapping portion 54 is bonded to the front edge 57a, for example, by gluing. When the plate-shaped structure 50 is assembled into a box shape, a right edge 51c of the front cover portion 51 is adjacent to a front edge 58a of the right cover portion 58. The right edge 51c includes an overlapping portion 55 capable of overlapping the front edge 58a. The overlapping portion 55 is bonded to the front edge 58a, for example, by gluing. Incidentally, the position where the overlapping portion is provided can be changed as appropriate.

When the plate-shaped structure 50 is assembled into a box shape, a left edge 70c of the upper cover portion 70 is adjacent to an upper edge 57b of the left cover portion 57. The left edge 70c includes an overlapping portion 73 capable of overlapping the upper edge 57b. An insertion hole 74a that is linear along the left edge 70c is provided in the overlapping portion 73. The upper edge 57b of the left cover portion 57 includes an insertion portion 59 that can be inserted into the insertion hole 74a.

The lower cover portion 60 includes a first rear extension portion 61 extending from the entirety of a rear edge 60a of the lower cover portion 60. The upper cover portion 70 includes a second rear extension portion 71 extending from the entirety of a rear edge 70a of the upper cover portion 70. The first rear extension portion 61 and the second rear extension portion 71 have a rectangular or substantially rectangular shape when unfolded (see FIG. 6).

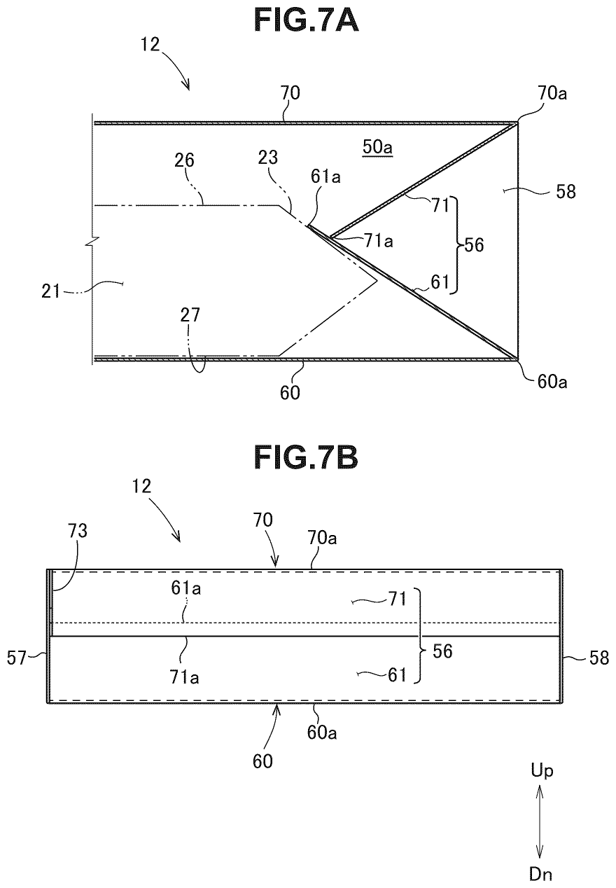

Referring to FIG. 7A, a space surrounded by the upper cover portion 70, the lower cover portion 60, the left cover portion 57, and the right cover portion 58 is referred to as a storage space 50a. The first rear extension portion 61 is inclined forward in the storage space 50a with the rear edge 60a of the lower cover portion 60 as a base point. A tip 61a of the first rear extension portion 61 is located in the storage space 50a (between the lower cover portion 60 and the upper cover portion 70). The first rear extension portion 61 is in contact with the rear portion 23 of the bag portion 21.

The second rear extension portion 71 is inclined forward in the storage space 50a with the rear edge 70a of the upper cover portion 70 as a base point. A tip 71a of the second rear extension portion 71 is located in the storage space 50a (between the lower cover portion 60 and the upper cover portion 70). The tip 71a of the second rear extension portion 71 is in contact with the first rear extension portion 61. Incidentally, the tip 61a of the first rear extension portion 61 may be configured to come into contact with the second rear extension portion 71.

Referring to FIG. 7B, the first rear extension portion 61 and the second rear extension portion 71, as a whole, define the rear cover portion 56 capable of covering the rear portion 23 of the ink pouch 20 from the rear. It can also be said that the rear cover portion 56 is a portion that closes the rear of the storage space 50a. In other words, when the pouch storage body 12 is viewed from the rear along the length direction of the ink pouch 20 (the state illustrated in FIG. 7B), the ink pouch 20 is not visible.

The pouch storage body 12 illustrated in FIG. 5 is formed by assembling one plate-shaped structure 50 illustrated in FIG. 6 into a box shape. Namely, the entirety of the bag portion 21 of the ink pouch 20 (see FIG. 2) can be covered by folding one plate-shaped structure 50 into a box shape. Compared to the conventional art, the entirety of the bag portion 21 (the front, rear, left, right, top, and bottom) can be covered with a simple configuration, and manufacturing costs can be reduced.

The material of the plate-shaped structure 50 is coated cardboard. The manufacturing costs of the pouch storage body 12 can be reduced.

Referring to FIG. 5 and FIG. 6, the overlapping portion 53 is bonded to the front edge 70b, for example, by gluing. Furthermore, the insertion portion 59 is inserted into the insertion hole 74a. Therefore, when the plate-shaped structure 50 is assembled into a box shape, the pouch storage body 12 is easily maintained in a box shape, and ultraviolet light is prevented from entering through a gap between adjacent edges (for example, the edges 51a and 70b or the edges 57b and 70c).

Referring to FIG. 6 and FIG. 7A, the lower cover portion 60 includes the first rear extension portion 61 extending from the entirety of the rear edge 60a of the lower cover portion 60. The upper cover portion 70 includes the second rear extension portion 71 extending from the entirety of the rear edge 70a of the upper cover portion 70. The first rear extension portion 61 and the second rear extension portion 71 constitute the rear cover portion 56 (end cover portion) capable of covering the rear portion 23 of the bag portion 21 from the rear.

Namely, the rear cover portion 56 is formed solely by folding the first rear extension portion 61 and the second rear extension portion 71 of the plate-shaped structure 50 into the storage space 50a as illustrated in FIG. 7A. The overlapping portions 53 to 55 provided in the front cover portion 51 are unnecessary, so that a simple configuration is achieved. Incidentally, as a configuration to cover the rear portion 23 of the bag portion 21 from the rear, a configuration equivalent to the front cover portion 51 and the overlapping portions 53 to 55 may be adopted instead of the rear cover portion 56.

Referring to FIG. 7A, in addition, the tip 71a of the second rear extension portion 71 is in contact with the first rear extension portion 61. In detail, the second rear extension portion 71 presses the first rear extension portion 61 against the rear portion 23 of the bag portion 21 due to the restoring force of the second rear extension portion 71 (the force with which the second rear extension portion 71 tends to return to an unfolded state (see FIG. 6)). A configuration in which a gap is provided between the tip 71a of the second rear extension portion 71 and the first rear extension portion 61 may be used. However, if the tip 71a is configured to come into contact with the second rear extension portion 71, ultraviolet light can be more reliably prevented from entering the storage space 50a.

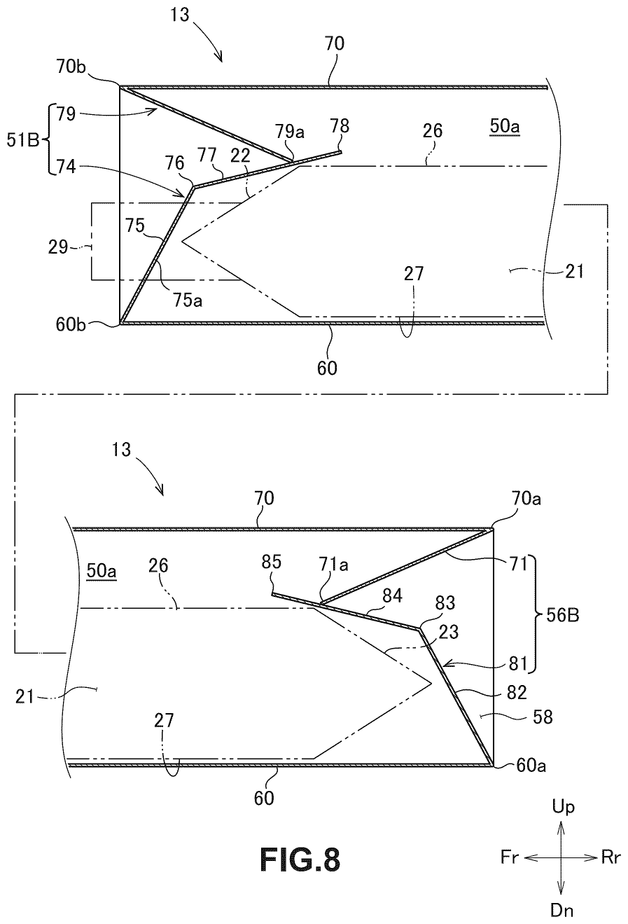

FIG. 8 illustrates a pouch storage body 13 according to a third example embodiment. Configurations and effects common to the pouch storage body 12 of the second example embodiment are denoted by the same reference numerals as those in the second example embodiment, and the description thereof will not be repeated.

The lower cover portion 60 includes a first front extension portion 74 extending from the entirety of a front edge 60b of the lower cover portion 60. The first front extension portion 74 is bent rearward.

In detail, the first front extension portion 74 includes a front lower portion 75 extending from the front edge 60b of the lower cover portion 60, and a front upper portion 77 extending from a tip 76 of the front lower portion 75. The front lower portion 75 is inclined rearward with the front edge 60b as a base point.

The tip 76 of the front lower portion 75 and a tip 78 of the front upper portion 77 are located in the storage space 50a. The tip 78 of the front upper portion 77 is located above and behind the tip 76 of the front lower portion 75. The front lower portion 75 has a through-hole 75a that the supply portion 29 can penetrate. The front upper portion 77 is in contact with the front portion 22 of the bag portion 21.

The upper cover portion 70 includes a second front extension portion 79 extending from the entirety of the front edge 70b of the upper cover portion 70. The second front extension portion 79 is inclined rearward with the front edge 70b as a base point. A tip 79a of the second front extension portion 79 is in contact with the front upper portion 77. Incidentally, the tip 79a may be configured to come into contact with the front lower portion 75.

The first front extension portion 74 and the second front extension portion 79 define a front cover portion 51B (end cover portion) capable of covering the front portion 22 of the bag portion 21 from the front.

The lower cover portion 60 includes a first rear extension portion 81 extending from the entirety of the rear edge 60a of the lower cover portion 60. The first rear extension portion 81 is bent forward.

In detail, the first rear extension portion 81 includes a rear lower portion 82 extending from the rear edge 60a of the lower cover portion 60, and a rear upper portion 84 extending from a tip 83 of the rear lower portion 82. The rear lower portion 82 is inclined forward with the rear edge 60a as a base point.

The rear upper portion 84 is in contact with the rear portion 23 of the bag portion 21. The tip 83 of the rear lower portion 82 and a tip 85 of the rear upper portion 84 are located in the storage space 50a. The tip 85 of the rear upper portion 84 is located above and in front of the tip 83 of the rear lower portion 82. The rear upper portion 84 is in contact with the rear portion 23 of the bag portion 21. The tip 71a of the second rear extension portion 71 is in contact with the rear upper portion 84. Incidentally, the tip 71a may be configured to come into contact with the rear lower portion 82.

The first rear extension portion 81 and the second rear extension portion 71 constitute a rear cover portion 56B (end cover portion) capable of covering the rear (the rear portion 23 of the bag portion 21) of the storage space 50a from the rear.

The overlapping portions 53, 54, and 55 in the second example embodiment (see FIG. 5) are unnecessary, so that the assembly of the pouch storage body 13 is made easier. Furthermore, compared to the first rear extension portion 61 of the first example embodiment (see FIG. 7A), the space between the first rear extension portion 81 and the lower cover portion 60 of the third example embodiment can be expanded.

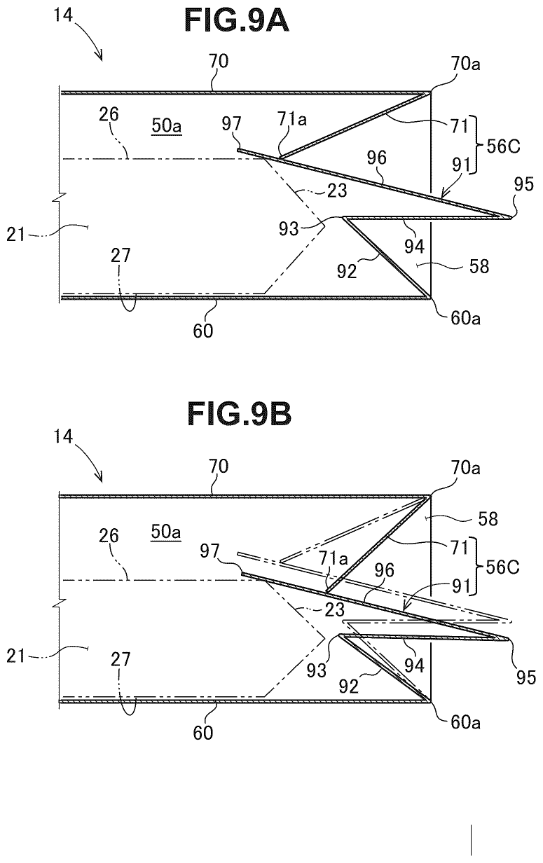

FIG. 9A illustrates a pouch storage body 14 according to a fourth example embodiment. Configurations and effects common to the pouch storage body 12 of the second example embodiment are denoted by the same reference numerals as those in the second example embodiment, and the description thereof will not be repeated.

A first rear extension portion 91 is folded in a bellows shape. In detail, the first rear extension portion 91 includes a rear lower portion 92 extending from the rear edge 60a of the lower cover portion 60, a rear middle portion 94 extending from a tip 93 of the rear lower portion 92, and a rear upper portion 96 extending from a tip 95 of the rear middle portion 94. The tip 93 of the rear lower portion 92 is located in the storage space 50a. The tip 95 of the rear middle portion 94 is located behind the storage space 50a. A tip 97 of the rear upper portion 96 is located in the storage space 50a. The tip 71a of the second rear extension portion 71 is in contact with the rear upper portion 96.

Referring to FIG. 9B, when the remaining amount of ink with which the bag portion 21 is filled decreases, the bag portion 21 becomes thinner. The first rear extension portion 91 can follow the ink pouch 20.

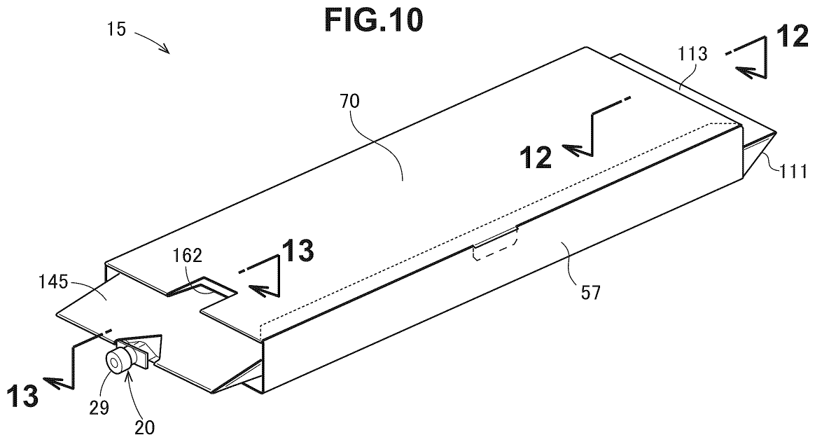

FIG. 10 illustrates a pouch storage body 15 according to a fifth example embodiment. Configurations and effects common to the pouch storage body 12 of the second example embodiment are denoted by the same reference numerals as those in the second example embodiment, and the description thereof will not be repeated.

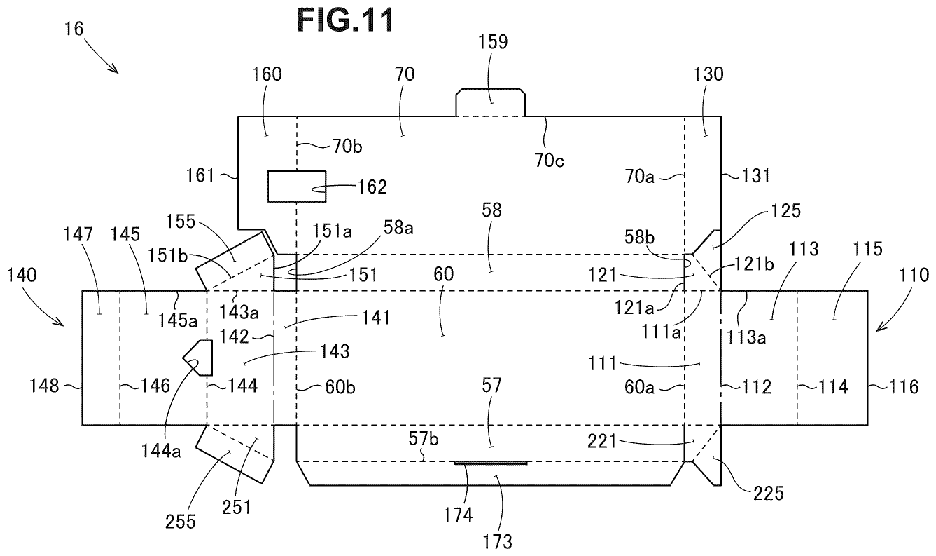

FIG. 11 illustrates the unfolded state of the pouch storage body. With reference to the unfolded state, a first rear extension portion 110 includes a rear base portion 111 having a rectangular or substantially rectangular shape and extending rearward from the entirety of the rear edge 60a of the lower cover portion 60, a rear middle portion 113 having a rectangular or substantially rectangular shape and extending from the entirety of a rear end 112 of the rear base portion 111, and a rear end portion 115 having a rectangular or substantially rectangular shape and extending from the entirety of a rear end 114 of the rear middle portion 113.

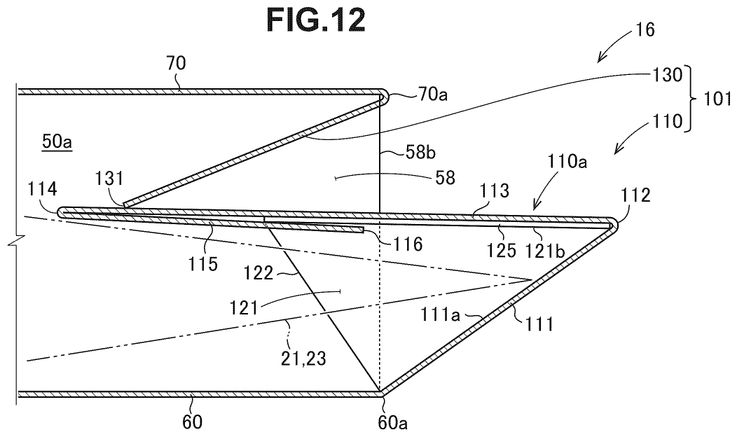

Referring to FIG. 11 and FIG. 12, with reference to the assembled state, the rear end 112 of the rear base portion 111 is located behind the storage space 50a. The rear end 114 of the rear middle portion 113 is located in the storage space 50a. Namely, the rear base portion 111 and the rear middle portion 113 define a rear protruding portion 110a protruding rearward from the storage space 50a.

The right side of the rear protruding portion 110a is covered by a rear right cover portion 121. Therefore, the rear right cover portion can block ultraviolet light entering the storage space 50a. The rear right cover portion 121 has a substantially right-angled triangular shape, and is connected to a right edge 111a of the rear base portion 111. The rear right cover portion 121 includes a rear right right-angle forming edge 121a forming a right angle together with the right edge 111a. The rear right right-angle forming edge 121a overlaps a rear edge 58b of the right cover portion 58 when unfolded.

A rear right overlapping portion 125 capable of overlapping a right edge 113a of the rear middle portion 113 is connected to an oblique side 121b of the rear right cover portion 121. A rear end 116 of the rear end portion 115 is located below the rear middle portion 113. In detail, the rear right overlapping portion 125 is sandwiched between the rear middle portion 113 and the rear end portion 115 located above the bag portion 21. Therefore, during assembly, the rear right cover portion 121 can be secured in a predetermined position.

A rear end 131 of a second rear extension portion 130 can come into contact with the rear middle portion 113. The first rear extension portion 110 and the second rear extension portion 130 define a rear cover portion 101 (end cover portion) capable of covering the rear (the rear portion 23 of the bag portion 21) of the storage space 50a from the rear.

Referring to FIG. 11, the configurations of a rear left cover portion 221 and a rear left overlapping portion 225 are symmetrical to those on the right side, and correspond to the above description with “right” replaced by “left”. The description will not be repeated.

With reference to the unfolded state illustrated in FIG. 11, a first front extension portion 140 includes a first portion 141 extending from the entirety of the front edge 60b of the lower cover portion 60, a second portion 143 extending from the entirety of a front end 142 of the first portion 141, a third portion 145 extending from the entirety of a front end 144 of the second portion 143, and a fourth portion 147 extending from the entirety of a front end 146 of the third portion 145.

The front end 144 of the second portion 143 has a through-hole 144a, through which the supply portion 29 (see FIG. 10) can penetrate, at the center in the left-right direction. An opening portion 162 is provided at the center of the front edge 70b of the upper cover portion 70 in the left-right direction.

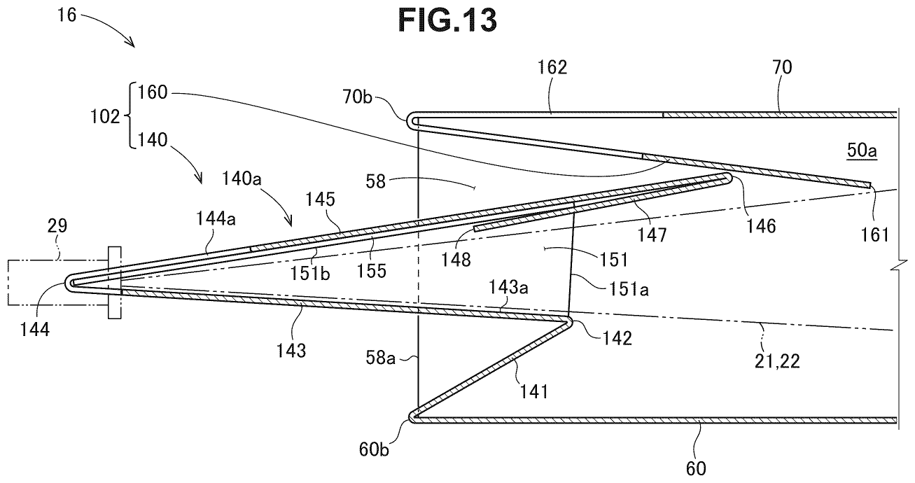

Referring to FIG. 11 and FIG. 13, with reference to the assembled state, the front end 142 of the first portion 141 is located in the storage space 50a. The front end 144 of the second portion 143 is located in front of the storage space 50a. The front end 146 of the third portion 145 is located in the storage space 50a and behind the front end 142 of the first portion 141. Namely, the second portion 143 and the third portion 145 define a front protruding portion 140a protruding forward from the storage space 50a. The bag portion 21 can be located inside the front protruding portion 140a.

The right side of the front protruding portion 140a is covered by a front right cover portion 151. Therefore, the front right cover portion 151 can block ultraviolet light entering the storage space 50a. The front right cover portion 151 has a substantially right-angled triangular shape, and is connected to a right edge 143a of the second portion 143. The front right cover portion 151 includes a front right right-angle forming edge 151a forming a right angle together with the right edge 143a. The front right right-angle forming edge 151a is located on a right extension line of the front end 142 of the first portion 141.

A front right overlapping portion 155 capable of overlapping a right edge 145a of the third portion 145 is connected to an oblique side of the front right cover portion 151. A front end 148 of the fourth portion 147 is located below the third portion 145. In detail, the front right overlapping portion 155 is sandwiched between the third portion 145 and the fourth portion 147 located above the bag portion 21. Therefore, during assembly, the front right cover portion 151 can be secured in a predetermined position.

The front end 146 of the third portion 145 can come into contact with a second front extension portion 160. A front end 161 of the second front extension portion 160 can come into contact with the front portion 22 of the bag portion 21. The first front extension portion 140 and the second front extension portion 160 define a front cover portion 102 (end cover portion) capable of covering the front portion 22 of the bag portion 21 from the front.

Referring to FIG. 11, the configurations of a front left cover portion 251 and a front left overlapping portion 255 are symmetrical to those on the right side, and correspond to the above description with “right” replaced by “left”. The description will not be repeated. The upper edge 57b includes an overlapping portion 173 capable of overlapping the left edge 70c. An insertion hole 174 that is linear along the upper edge 57b is provided in the upper edge 57b. The left edge 70c includes an insertion portion 159 that can be inserted into the insertion hole 174.

Incidentally, the present invention is not limited to the first to fifth example embodiments as long as the actions and effects of the present invention are achieved. Furthermore, the elements or features of each example embodiment can be combined as appropriate.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A pouch storage body capable of storing an ink pouch including a bag portion filled with printing ink that is curable when irradiated with ultraviolet light, and a supply portion to supply the printing ink, with which the bag portion is filled, to an outside, the pouch storage body comprising:
a storage housing with a tubular shape; and
a stored structure to be stored in the storage housing, together with the ink pouch; wherein
when a length direction of the ink pouch is defined as a front-rear direction, and a side on which the supply portion is provided is defined as a front, the stored structure includes a front wall portion to cover a front portion of the bag portion of the ink pouch from the front except for the supply portion, a rear wall portion to cover a rear portion of the bag portion of the ink pouch from a rear, and a connecting portion connecting the front wall portion and the rear wall portion.

2. The pouch storage body according to claim 1, wherein
the front wall portion includes a front surrounding portion extending rearward from an entire edge of the front wall portion and to surround the front portion of the bag portion; and
the rear wall portion includes a rear surrounding portion extending forward from an entire edge of the rear wall portion and to surround the rear portion of the bag portion.

3. A pouch storage body comprising:
a storage to store an ink pouch including a bag portion filled with printing ink that is curable when irradiated with ultraviolet light, and a supply portion to supply the printing ink, with which the bag portion is filled, to an outside; and
a plate-shaped structure with a box shape to cover an entirety of the bag portion of the ink pouch except for the supply portion.

4. The pouch storage body according to claim 3, wherein the plate-shaped structure is made of coated cardboard.

5. The pouch storage body according to claim 4, wherein
an edge of the plate-shaped structure includes an overlapping portion to overlap an edge adjacent to the edge when the plate-shaped structure is assembled into a box shape; and
the overlapping portion is bonded to the adjacent edge or an insertion portion provided in the adjacent edge is inserted into an insertion hole in the overlapping portion.

6. The pouch storage body according to claim 3, further comprising:
a lower cover portion to cover a lower portion of the bag portion;
an upper cover portion to cover an upper portion of the bag portion; and
an end cover portion to cover at least one of a front portion or a rear portion of the bag portion; wherein
the end cover portion includes a first extension portion extending from an edge of the lower cover portion, and a second extension portion extending from an edge of the upper cover portion; and
both a tip of the first extension portion and a tip of the second extension portion are located between the lower cover portion and the upper cover portion.
